(19) United States
(12) Patent Application Publication
(10) Pub. No.: US 2017/0286928 A1
(43) Pub. Date: Oct. 5, 2017

(54) WIRELESS SYSTEMS AND METHODS FOR BILL PAYMENT

(71) Applicant: Glance Pay Inc., Vancouver (CA)

(72) Inventor: Desmond Griffin, Vancouver (CA)

(73) Assignee: Glance Pay Inc., Vancouver (CA)

(21) Appl. No.: 15/471,303

(22) Filed: Mar. 28, 2017

Related U.S. Application Data
(60) Provisional application No. 62/316,218, filed on Mar. 31, 2016.

(51) Int. Cl. G06Q 20/10; G06K 9/00; G06Q 20/32

(52) U.S. Cl. CPC G06Q 20/102; G06Q 20/3224; G06K 9/00442

(57) ABSTRACT

Methods, systems and devices for creating an electronic payment transaction of a bill are described. The bill may be a paper bill and an image of the bill may be captured with a user device and sent to a server. The user device may also obtain and send location information to the server. One method includes the server receiving the image of the bill; analyzing the received image to determine at least a billed amount; determining a retailer associated with the billed amount; sending a request to the user to confirm at least the billed amount; and in response to receiving confirmation from the user of a confirmed payment amount, creating an electronic payment transaction.

### CROSS REFERENCE TO RELATED APPLICATION

This application is claims priority to U.S. Provisional Patent Application Ser. No. 62/316,218, filed Mar. 31, 2016, entitled WIRELESS SYSTEMS AND METHODS FOR BILL PAYMENT.

### TECHNICAL FIELD

Example embodiments relate to the fields of electronic payment transactions and systems and methods for enabling online payment of invoices.

### BACKGROUND

Traditional bill payment systems in retail establishments, such as restaurants, typically require a customer to pay by cash or by using a payment machine for a credit card or debit card. The payment machine may require a customer to either go to the payment machine or rely on a staff member to bring a wireless payment machine to the customer. The payment machines may be limited in number and may not be secure for the transmission of credit or debit card and personal information.

### SUMMARY

According to one embodiment of the present application there is provided a method of creating an electronic payment transaction. The method includes receiving an image of a bill; analyzing the received image to determine at least a billed amount; determining a retailer associated with the billed amount; sending a request to a user to confirm at least the billed amount; and in response to receiving confirmation from the user of a confirmed payment amount, creating an electronic payment transaction to deduct the confirmed payment amount from an account associated with the user and to provide a payment to an account associated with the retailer for the confirmed amount.

In another embodiment, there is provided a non-transitory computer readable storage medium having stored thereon computer-readable and computer-executable instructions, which, when executed by a processor, cause the processor to perform actions of receiving an image of a bill; analyzing the received image to determine at least a billed amount; determining a retailer associated with the billed amount; sending a request to a user to confirm at least the billed amount; and in response to receiving confirmation from the user of a confirmed payment amount, creating an electronic payment transaction to deduct the confirmed payment amount from an account associated with the user and to provide a payment to an account associated with the retailer for the confirmed amount

In another embodiment, there is provided a non-transitory computer readable storage medium having stored thereon computer-readable and computer-executable instructions, which, when executed by a processor, cause the processor to perform actions of receiving an image of a bill; analyzing the received image to determine at least a billed amount; determining a retailer associated with the billed amount; sending a request to a user to confirm at least the billed amount; and in response to receiving confirmation from the user of a confirmed payment amount, creating an electronic payment transaction to deduct the confirmed payment amount from an account associated with the user and to provide a payment to an account associated with the retailer for the confirmed amount

In another embodiment, there is a non-transitory computer readable storage medium having stored thereon computer-readable and computer-executable instructions, which, when executed by a processor in a wireless communications device, causes the wireless communications device to perform actions of capturing an image of a bill; transmitting the captured image of the bill to a server; receiving a request to confirm payment of a billed amount associated with the captured image; and transmitting a confirmation of a confirmed payment amount to the server.

### BRIEF DESCRIPTION OF THE DRAWINGS

Reference will now be made, by way of example, to the accompanying figures which show example embodiments of the present application, and in which:

FIG. 1 is a block diagram illustrating a system in accordance with one embodiment of the present disclosure;

FIG. 2 is a flowchart of a method in accordance with one embodiment of the present disclosure;

FIG. 3 is a flowchart of a method in accordance with one embodiment of the present disclosure; and

FIGS. 4(a) to 4(d) are sample user interface displays in accordance with one embodiment of the present disclosure.

Like reference numerals are used throughout the Figures to denote similar elements and features

While the invention will be described in conjunction with the illustrated embodiments, it will be understood that it is not intended to limit the invention to such embodiments. On the contrary, it is intended to cover all alternatives, modifications and equivalents that may be included within the spirit and scope of the invention described herein.

### DETAILED DESCRIPTION OF EXAMPLE EMBODIMENTS

The present application describes methods, devices and systems which enable a user to create an electronic transaction for payment of a bill or invoice associated with a retailer or retail establishment. The customer or user captures an image of the bill with a wireless communications device and sends the image to a server operated by an electronic transaction service provider. The service provider server analyzes the captured image to determine at least the amount billed, and the retail establishment associated with the bill. The server sends a request to the user to confirm at least the payment of the billed amount. The user may confirm the retail establishment and billed amount and may take other steps, such as to add a tip to the billed amount or to pay only a portion of the billed amount. Upon receipt of confirmation from the user, the server processes payment to deduct the confirmed amount from an account associated with the user and to provide payment to the retail establishment. The server may also send a notification to the retail establishment and/or to a staff person associated with the bill in order to confirm that payment of a particular invoice has been received.

Thus, the user may pay a bill through the use of his or her own wireless device, without having to wait for the use of a point of sale (POS) terminal provided by the retail establishment. Payment is made using an account securely maintained by the service provider and without the user providing credit card information to the retailer or a third party in an unsecured or less secure environment of the retail establishment. While other software applications exist to facilitate payment for goods or services, these may require a significant level of integration with the payment or POS system used by the retail establishment. The methods, devices and systems described herein may also be used by a retailer or retail establishment that does not have a POS system.

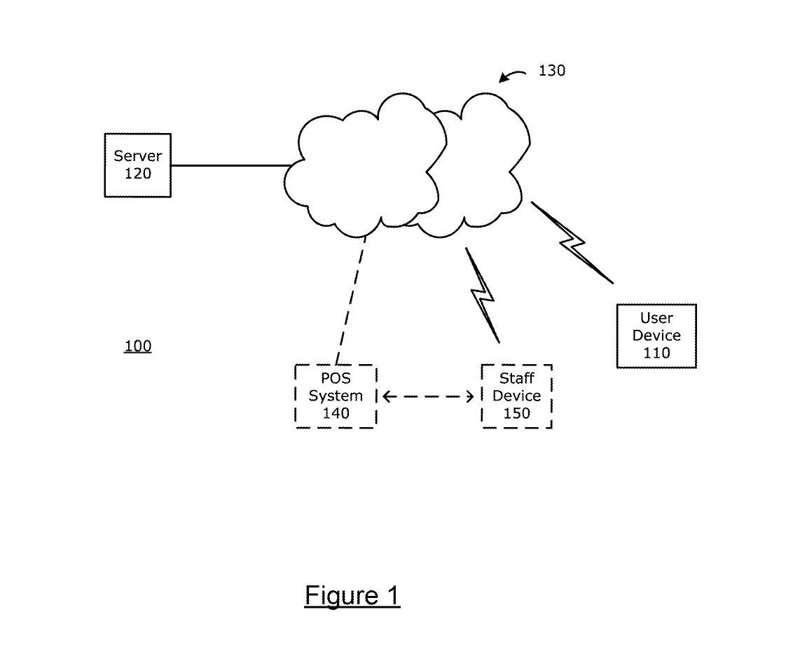

The methods, devices and systems of the present application are described in further detail below. FIG. 1 illustrates a system 100 according to one embodiment of the present application. The system includes one or more user devices 110 which are used by users to capture and send an image of a bill to a server 120 of an electronic transaction service provider. The user device 110 has a processor and a memory configured to store and execute instructions for the electronic transaction software applications described herein. The user device 110 is configured to support wireless communications and a user interface with a display screen, keypad or buttons, and other inputs/outputs. The user device also includes an image capture component such as a camera or scanner which is configured to capture and create an image or electronic representation of a bill. The user device 110 may be a mobile phone, cellular phone, smart phone, tablet, smart watch, or other wireless communications device.

The communications between the user device 110 and server 120 are achieved through a communications network 130. The network 130 includes one or more wired or wireless networks such as a cellular telecommunications network, a wireless local area network (WLAN), such as a network operating according to the IEEE 802.11 standard or WiFi™, or combinations thereof, including the Internet and related backbone networks (not shown).

The system 100 may include a POS system 140 or other computing device of the retail establishment which is used, for example, to track orders received from customers, to issue bills, to accept payments via wired or wireless payment machines, or to provide a combination of these functions. The POS system 140 also may communicate with the server 120 through the network 130. In some embodiments, there may be additional staff devices 150 associated with the staff of the retail establishment. The staff devices 150 may be wireless devices similar to user devices 110 and may receive wireless communications from the server 120 of the electronic transaction service provider. Alternatively or additionally, the staff devices 150 may be part of the POS system 140 and/or may exchange communications with the POS system 140. Each of the POS system 140 and staff device 150 includes a processor and a memory configured to store and execute instructions for the electronic transaction software applications described herein. Each of the POS system 140 and the staff device 150 is configured to support wired and/or wireless communications and may include a user interface with a display screen, keypad or buttons, and other inputs/outputs.

To receive the services described herein, a user creates a customer account with the electronic transaction service provider and receives a user software application to be executed by their user device 110 to carry out the methods described herein. The user typically provides personal information to the electronic transaction service provider which can be used to identify and authenticate the user, such as one or more telephone numbers, addresses, passwords, user names, identifiers associated with the user's user device 110, or combinations thereof. The user also typically provides data for at least one financial account or instrument such as a credit card, debit card, bank, online currency or other account, which is used to provide payments authorized by the user. The customer account may be created at any time through the network 130. It will be appreciated that a user may choose to create an account at a time when the user has secure access to the network 130, such as through a home network or other interface with greater security than, for example, an unrestricted or free public WLAN. In some embodiments, the user may enter or select one or more preferences associated with the customer account and electronic transaction services. Such preferences may include, for example, preferred payment tips, tip percentage preferences, and loyalty rewards accounts or information.

The retail establishment creates a retail account with the electronic transaction service provider. Example embodiments are described herein for a retail establishment such as a restaurant, café, bar, lounge or other establishment providing food and/or beverage services. It will be appreciated, however, that the embodiments described herein are not limited to a particular type of retailer or retail establishment or to a particular type of goods or services. The systems and methods described herein may be used for any retailer, retail establishment, or business that provides printed or paper bills or invoices to customers. In some embodiments, the bill may be displayed in another system or medium, such as on a computer, terminal or other display and the image of the bill may be captured or photographed from that display. The retail establishments or retailers may have a temporary or permanent site or structure and also may include, for example, food trucks, pop-up restaurants, retail clothing stores, special events or markets. The embodiments described herein may be used to create an electronic payment transaction for a bill received by a customer for goods/services received by the customer and for which immediate payment is required or preferred.

The retail establishment provides information to the electronic transaction service provider consisting of contact information and banking or financial account information which enables the electronic transaction service provider to provide payments from the users and customer accounts to the retail account. A separate retail account may be created for each location of a retail establishment. Alternatively, one account may be created for a retail establishment with different banking information provided for each location of that establishment.

The retail establishment also may provide sample bills or invoices and/or an indication of a bill format or standard to the electronic transaction service provider. This information may be provided when the retail account is created, or at a later date, and also may be updated by the retail establishment as bills or formats change. The retail establishment also may provide other information to the electronic transaction service provider, including for example, location information and/or identifiers for the retailer or establishment, or for tables or other specific sites at each location of the retail establishment. The retail establishment also may provide staff identifiers, which may be associated with and/or displayed on a bill, and/or email addresses associated with the staff and staff devices 150. The sample bills or invoices, and format or other information may be used by the server 120 to determine a bill format associated with the retail establishment and to improve the analysis of bills scanned and submitted by users, as described below.

The retail establishment also may receive a software application to be executed by the POS system and/or a software application for execution by staff devices 150 to carry out the methods described herein. The retail account may include contact information, such as email addresses, telephone numbers or messaging system identifiers, for the retail establishment and its staff. Thus, in some embodiments, additional software applications and/or integration of the POS system 140 with the system 100 is not required. The retail establishment and/or its staff may simply receive notification by an email, text or other message that a bill has been paid.

The information received and/or created for each customer and retail account may be encrypted and securely stored by the server 120. The server 120 is configured to maintain the accounts and exchange messages with the user devices 110, staff devices 150 and POS systems 140. The server 120 includes a communications interface, a processor and a memory configured to store and execute instructions for the software applications and functions described herein. While shown as a single entity, the server 120 may consist of multiple processing, storage and communication devices and interfaces configured to carry out the functions described herein. The server 120 also is configured to exchange messages or instructions electronically with one or more financial institutions (not illustrated in FIG. 1) in order to effect and resolve payments between customer accounts and the bank accounts for one or more locations of the retail establishment.

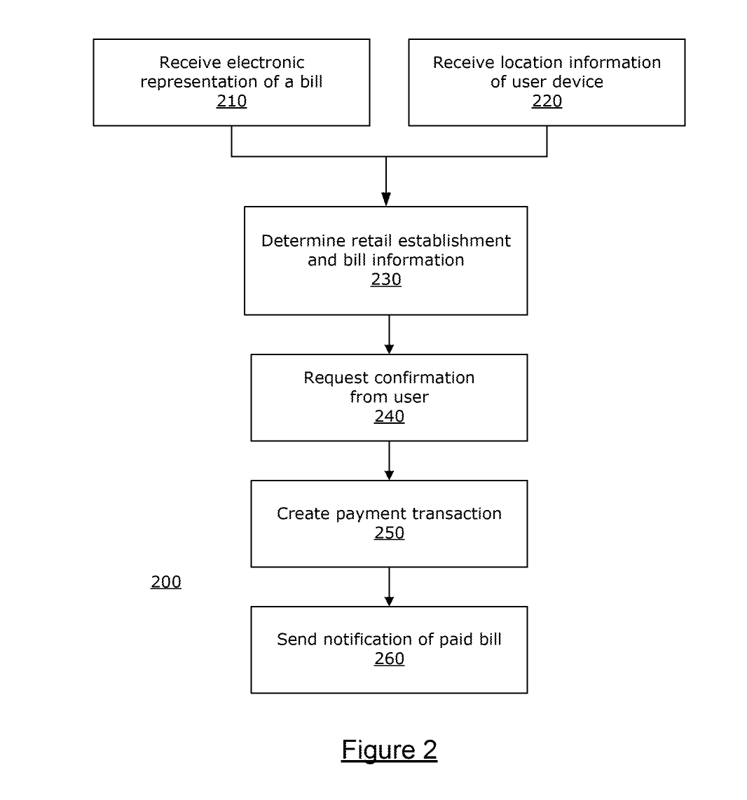

FIG. 2 illustrates one embodiment of a method 200 provided by the server 120 of an electronic transaction service provider. The server 120 receives an electronic representation of a bill (action 210) from a user device 110. The electronic representation is typically an electronic image or photograph of the bill which has been captured and transmitted by a user and the electronic transaction software application executed by the user device 110. A customer account number or other identifier associated with the user is also received by the server. In some cases, the server 120 may prompt the user device 110 to provide additional authentication information for the user in order to ensure access to the user's account, and payment authority provided through the electronic transaction application, remain secure.

The server 120 may receive (action 220) additional or extrinsic information from the user device 110 which may be used to identify the format of the bill. When the electronic transaction application is initiated on the user device 110, it may determine a location of the user device 110 using one or more technologies or other applications supported by the user device 110. The location information may include, for example, global positioning system (GPS) information, location information based on a cell or telecommunications coverage area in which the user device 110 is located, location information based on a WLAN network, identifiers or detailed location information about the user device 110 within a location of the retail establishment, as described below, or combinations thereof. In some embodiments, the user may enter or select a location and/or retail establishment within the electronic transaction software application. The location information of the user device 110 may be transmitted to the server 120 separately or along with the electronic representation of the bill.

The server 120 analyzes the received image to determine the format of the bill and/or the retail establishment associated with the bill (action 230). This determination may be based on the received image and sample invoices or bills, format information and other information previously provided to the server 120; past processing of other bills from the same retail establishment; past processing of similar bill formats from other retail establishments; location information and/or identifiers provided by the user device 110; or combinations of this information. The information displayed on the bill may be computer-generated or hand-printed and may be captured using optical character recognition (OCR) and/or intelligent character recognition (ICR) techniques.

By using additional information which is provided by the user device 110, available from the retail account, and/or known from past bill processing, the capture of information from the image of the bill by the server 120 may be improved. Common patterns from prior OCR scanning results thus may be used by the server 120 to customize OCR algorithms to improve recognition accuracy for a particular bill format which is associated with a particular location and/or retailer. It will be appreciated that OCR scanning results may vary, particularly if the information is captured from photographs which vary in lighting and quality. If the associated or expected bill format has been determined for a particular image, then the scanning by the server 120 may be modified or verified for information which is expected to be provided in a certain location on the bill. For example, the server 120 may process an image but have results such as “table number” missing. If the server 120 has learned that the table number should be the third number that results from a scan for the given bill format, the table number may still be identified from the image sent from the user device 110.

The amount due for the bill and other information also may be determined or identified and captured from the image. This information is digitized as needed and retained by the server 120. The retained information may include a bill number; the retail establishment name, account and/or location identifier; an amount owed to the retail establishment; a table number or other site identifier; the name and/or number of a staff person such as a waiter or server associated with the bill or table; a till number; a product or service identifier; or combinations thereof.

After information is determined for the bill, the server 120 creates and sends a request to the user device 110 (action 240) to confirm payment of the bill. The request to the user device 110 may include the name and location of the retail establishment and the amount to be paid for the bill. In some embodiments, the request may provide a suggested tip to be added to the bill based on the preferences stored for the customer account associated with the user. In some embodiments, the request displayed to the user may enable a user to pay only a portion of the bill based on a percentage or dollar amount.

After confirmation is received from the user device to proceed with payment, the server 120 causes an electronic payment transaction to occur (action 250) so that payment for the confirmed amount of the bill is deducted from the customer account associated with the user and credited to the retail account associated with the retail establishment.

The server 120 may not retain or provide funds to either the customer or retail establishment. Instead, the server 120 securely requests and authorizes the appropriate payment or credit transactions between the financial account of the customer, and the bank or financial account associated with the retail establishment or a specific location of the retail establishment. It will be appreciated that the server 120 also may be configured to support other types of payment transactions such as a deduction from a customer's rewards account and a corresponding update or notification to the retail account when a customer redeems rewards points, coupons, promotional offers etc. In some embodiments, the payment is processed in real time to effect payment directly between the customer or user and the retail establishment. In other embodiments deductions from a customer account and/or payments to a retail account may be grouped for processing later in order to reduce processing costs.

The server 120 may send a confirmation to the user device 110 to confirm that the instructions have been received and the payment has been processed. The user may be provided with a confirmation number or other identifier in order to track the transaction. In some embodiments, the method 200 includes the server 120 sending a notification to the retail establishment (action 260) that the bill has been paid. This notification may consist of an email, text or other message to the staff associated with a particular bill and retail establishment to confirm that the bill has been paid. The bill may be identified by a bill number, table number, or a staff name or number, till number, product identifier, a confirmation number, transaction number, or a combination thereof. If the staff person has a staff device 150 configured with the electronic transaction software application described herein, the notification may be provided through a screen display and/or other interface or indicator on the staff device 150, such as an audible alert, flashing light or vibration of the device. Similarly, if the POS system 140 is configured with the electronic transaction software application described herein, the notification may be provided through a screen display or other interface and/or alert on the POS system 140. In some embodiments, the notifications to each staff device 150 and to the POS system 140 may be customized to each particular staff member, or to provide a summary for the tables or sites and bills associated with the POS system 140 and each staff device 150.

In some embodiments, the amount confirmed by a user for the bill and paid by the server 120 at action 250, may be greater or less than the amount of the bill generated by the retail establishment. The difference may be caused by many factors such as a tip being added to the bill, or a user paying only their portion of the bill, as noted above, or a user confirming payment of an incorrect amount. In some embodiments, the users or staff of the retail establishment may request a change by the service provider in the amount which has been paid under the transaction. In some embodiments, the server 120 may be configured to accept and cause multiple payments for the same bill from multiple users executing the electronic transaction software applications described herein. Each user may scan and send the same bill and authorize payment of his or her portion of the bill. In other embodiments, the server 120 may notify the staff person and/or retail establishment associated with the bill that payment has been received but the complete bill or total amount owed has not been paid.

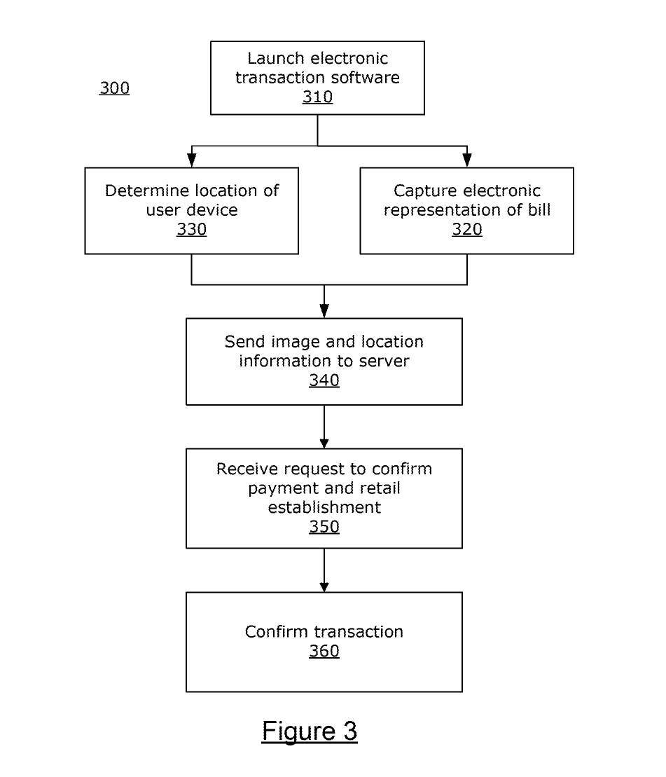

FIG. 3 illustrates a method 300 executed by a user device 110 according to embodiments described herein. The method includes the user device 110 receiving an instruction from a user to launch the electronic transaction software application (action 310). The user device 110 and software application enable the user to create an electronic representation of a bill received from a retail establishment (action 320). The bill be may photographed or scanned using the user device 110. At the same time as capturing the image of the bill, or when the application is first launched, or periodically thereafter, the electronic transaction software application causes the user device 110 to determine a location (action 330) of the user device 110. The location may be determined using GPS information; information based on a cell, telecommunications coverage area, or WLAN area in which the user device 110 is located; detailed or “micro-location” information received or determined by the user device 110 within a location of the retail establishment; or combinations thereof. In some embodiments, the location of the user device 110 may be determined by prompting the user to enter or confirm location information, such as a city, the name of the retail establishment, a specific location of a retail establishment, or a combination thereof.

In some embodiments, the retail establishment may have micro-location technology distributed within particular sites in the establishment or affixed to or associated with specific sites, such as tables in a restaurant. The micro-location technology may rely on near-field communications technologies such as BlueTooth™ and/or may use systems such as, but not limited to, the iBeacon™ proximity sensing protocols and technologies. From a micro-location transmitter close or closest to the user device 110, the user device 110 may receive an identifier for the retail establishment and/or a location identifier of the micro-location transmitter. The retail establishment identifier and location identifiers may correspond to the identifiers and information provided by the retail establishment when it created or updated its retail account. Alternatively, the retail establishment identifier and/or the location identifiers provided by the user device 110 from a micro-location transmitter may be added by server 120 to the retail account associated with the establishment as the server tracks and learns the identifiers when processing multiple bills for that establishment.

The electronic capture of the bill and any retail establishment or location information or identifiers may be transmitted to the server 120 by the user device 110 (action 340) through the communications network 130. The network 130 may include an unrestricted or free public WLAN, such as a WLAN provided by the retail establishment itself. Since the electronic transaction software application does not require a user to send sensitive financial information, such as a credit card number, to initiate payment of the bill, the use of a less secure wireless network may be acceptable to the user.

Once the bill and location information have been processed by the server 120, the user device 110 receives and displays (action 350) a request to confirm the payment of the bill as described above. The user may modify the details of the transaction and send confirmation to complete the transaction (action 360). In some embodiments, the user device 110 also may receive a confirmation that the transaction to pay the confirmed amount of the bill has been completed.

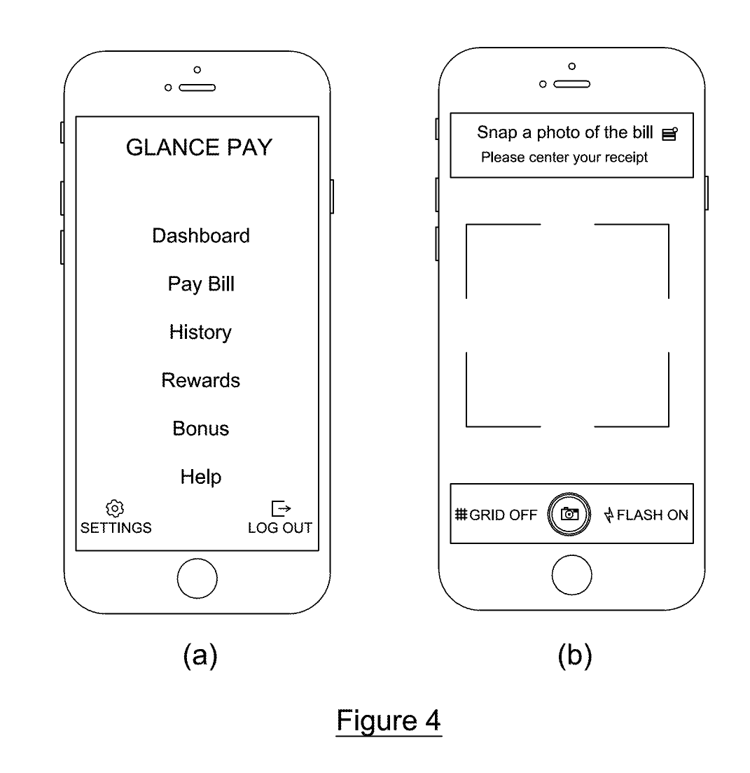

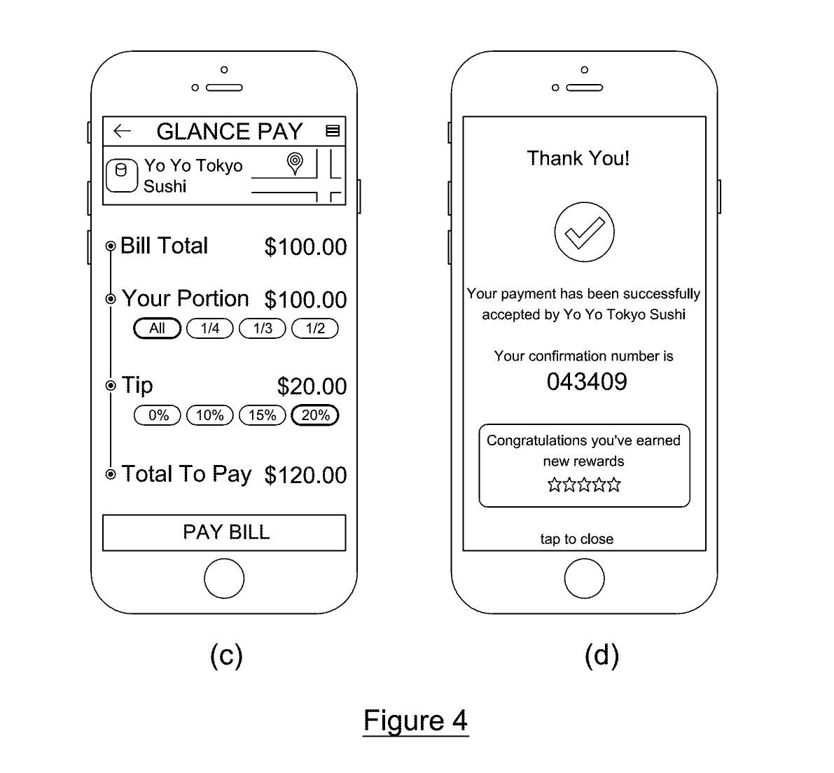

FIGS. 4(a)-(d) illustrate sample user displays or interfaces which may be shown on the device 110 during operation of the electronic transaction software application described herein. FIG. 4(a) illustrates a sample screen display or “dashboard” which appears after the electronic transaction software application is launched. In response to a user selecting the option to “pay bill”, the interface of FIG. 4(b) may be provided to enable the user to capture an image of the bill. Instructions and/or positive or negative feedback may be provided to the user via this interface to ensure that the user has centered the bill and that an acceptable image has been or will be captured.

FIG. 4(c) illustrates a sample interface presented to a user after the user device 110 has received the request from the server 120 to confirm the payment to the retail establishment. This interface may include the name and other identifying information of the retail establishment, including a mapped location. In some embodiments, the user may select the information such as the retail establishment or the displayed location in order to confirm or correct the information. The interface shown in FIG. 4(c) may also display the amount of the bill and options for the user to confirm payment of the entire bill, or only a portion of the bill, and to add a tip. In response to the user entering or selecting a command to “pay bill”, the user device 110 sends an instruction or message to the server 120 to pay the bill for the confirmed amount. FIG. 4(d) illustrates a sample display presented to a user after the electronic payment has been executed and the user device 110 has received confirmation from the server 120. The display may include a confirmation number for the transaction and other information or updates, such as reward program points earned by the user in association with the transaction.

Although the exemplary embodiments described herein employ the memory, other types of computer readable media which can store data that are accessible by a computer, such as magnetic cassettes, flash memory cards, digital versatile disks, cartridges, random access memories (RAMs), read only memory (ROM), USB or memory sticks, a cable or wireless signal containing a bit stream and the like, also may be used in the exemplary operating environment. Non-transitory computer-readable storage media expressly exclude media such as energy, carrier signals, electromagnetic waves and signals per se.

Thus, it is apparent that there has been provided in accordance with the embodiments of the present disclosure systems and methods for electronic payment transactions that fully satisfy the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

1. A method of creating an electronic payment transaction comprising,
receiving an image of a bill;
analyzing the received image to determine at least a billed amount;
determining a retailer associated with the billed amount;
sending a request to a user to confirm at least the billed amount; and
in response to receiving confirmation from the user of a confirmed payment amount, creating an electronic payment transaction to deduct the confirmed payment amount from an account associated with the user and to provide a payment to an account associated with the retailer for the confirmed amount.

2. The method of claim 1 further comprising sending a notification to the retailer confirming payment of the bill.

3. The method of claim 2 wherein analyzing the received image further comprises analyzing the received image to determine a staff person associated with the bill, and wherein sending the notification to the retailer comprises sending an email message to the associated staff person.

4. The method of claim 1 wherein receiving the image of the bill comprises receiving a photograph of the bill from a wireless communications device associated with the user.

5. The method of claim 1 wherein determining the retailer associated with the billed amount comprises analyzing the received image for bill format information and/or identifiers associated with the retailer, and determining the retailer based on the bill format information and/or identifiers.

6. The method of claim 1 wherein determining the retailer associated with the billed amount comprises receiving location information from a wireless communications device associated with the user, and determining the retailer based on the received location information, the received image, or a combination of the received location information and the received image.

7. The method of claim 6 wherein the location information comprises a global positioning system (GPS) location of the wireless communications device, a location of the wireless communications device in cellular communications network, a micro-location of the wireless communications device in a retail location associated with the retailer, an identifier associated with the retail location, a user selected location, or a combination of two or more thereof.

8. The method of claim 1 wherein analyzing the image further comprises identifying information from the image based on a bill format associated with the retailer.

9. The method of claim 1 wherein the image of the bill comprises a photograph of a paper bill captured by the wireless communications device.

10. The method of claim 1 wherein the confirmed payment amount is the same as the billed amount, is a portion of the billed amount, or exceeds the billed amount.

11. The method of claim 1, wherein sending the request to the user comprises sending a request to confirm the billed amount and the retailer associated with the billed amount.

12. The method of claim 1, further comprising executing the electronic payment transaction.

13. A non-transitory computer readable storage medium having stored thereon computer-readable and computer-executable instructions, which, when executed by a processor, cause the processor to perform actions of:
receiving an image of a bill;
analyzing the received image to determine at least a billed amount;
determining a retailer associated with the billed amount;
sending a request to a user to confirm at least the billed amount; and
in response to receiving confirmation from the user of a confirmed payment amount, creating an electronic payment transaction to deduct the confirmed payment amount from an account associated with the user and to provide a payment to an account associated with the retailer for the confirmed amount.

14. The non-transitory computer readable storage medium of claim 13 wherein analyzing the received image further comprises analyzing the received image to determine a staff person associated with the bill, and wherein the instructions, when executed, further cause the processor to send an email message confirming payment of the bill to the associated staff person.

15. The non-transitory computer readable storage medium of claim 13 wherein determining the retailer associated with the billed amount comprises analyzing the received image for bill format information and/or identifiers associated with the retailer and determining the retailer based on the bill format information and/or identifiers.

16. The non-transitory computer readable storage medium of claim 13 wherein determining the retailer associated with the billed amount comprises receiving location information from a wireless communications device associated with the user and determining the retailer based on the received location information, the received image, or a combination of the received location information and the received image.

17. The non-transitory computer readable storage medium of claim 16 wherein the location information comprises a global positioning system (GPS) location of the wireless communications device, a location of the wireless communications device in cellular communications network, a micro-location of the wireless communications device in a retail location associated with the retailer, an identifier associated with the retail location, a user selected location, or a combination of two or more thereof.

18. The non-transitory computer readable storage medium of claim 13 wherein analyzing the image further comprises identifying information from the image based on a bill format associated with the retailer.

19. A non-transitory computer readable storage medium having stored thereon computer-readable and computer-executable instructions, which, when executed by a processor in a wireless communications device, causes the wireless communications device to perform actions of:
capturing an image of a bill;
transmitting the captured image of the bill to a server;
receiving a request to confirm payment of a billed amount associated with the captured image; and
transmitting a confirmation of a confirmed payment amount to the server.

20. The non-transitory computer readable storage medium of claim 19 wherein the computer-executable instructions further cause the wireless communications device to display, on a user interface of the wireless communications device, the received request, the billed amount and one or more options for payment of the billed amount, payment of a portion of the billed amount, or payment exceeding the billed amount.

21. The non-transitory computer readable storage medium of claim 19 wherein the computer-executable instructions further cause the wireless communications device to determine a location of the wireless communications device and transmit the location to the server.

22. The non-transitory computer readable storage medium of claim 21 wherein the computer-executable instructions further cause the wireless communications device to determine the location based on global positioning system (GPS) coordinates of the wireless communications device, a location of the wireless communications device in cellular communications network, a micro-location of the wireless communications device in a retail location, an identifier associated with the retail location, a user selected location, or a combination of two or more thereof.
